(19) United States
(12) Patent Application Publication
(10) Pub. No.: US 2011/0301294 A1
(43) Pub. Date: Dec. 8, 2011

(54) PROCESS FOR PURIFYING POLYOL DISPERSIONS

(75) Inventors: Dejan PETROVIC, Ludwigshafen (DE); Christiane Parzyk, Stuttgart (DE)

(73) Assignee: BASF SE, Ludwigshafen (DE)

(21) Appl. No.: 13/153,923

(22) Filed: Jun. 6, 2011

Related U.S. Application Data
(60) Provisional application No. 61/352,413, filed on Jun. 8, 2010.

(51) Int. Cl. C08L 25/12

(52) U.S. Cl. 525/185

(57) ABSTRACT

The present invention relates to a process for purifying a polyol dispersion by stripping by means of at least one rotating body, to the polyol dispersion obtainable by the process according to the invention, and to the use thereof for preparing polyurethanes.

The present invention relates to a process for purifying a polyol dispersion by stripping by means of at least one rotating body, to the polyol dispersion obtainable by the process according to the invention, and to the use thereof for preparing polyurethanes.

### BACKGROUND

Polyol dispersions comprise a continuous phase (liquid at 25° C., 1013 mbar) and a solid phase dispersed in the continuous phase.

The continuous phase comprises at least one polyol, and optionally further components, for example a polyisobutene in addition. Polyols in the context of this invention are all compounds which have at least two alcohol groups.

The dispersed solid phase comprises at least one filler; the fillers are preferably selected from polymeric, organic or inorganic fillers, or a mixture thereof.

Graft polyols are a specific type of polyol dispersions. In the case of graft polyols, the fillers are selected from polymeric fillers, especially from copolymers of styrene with acrylonitrile.

In the present text, the terms “graft polyols”, “polymer polyols” and “polymer-filled polyols” are considered to be equivalent.

Graft polyols are used as a raw material in the polyurethane (PU) industry, in order to adjust the hardness properties and the elasticity properties in flexible PU foams. These graft polyols are generally polyetherols (continuous phase) filled with a copolymer of styrene and acrylonitrile (filler, solid phase). In the process for producing these products, styrene and acrylonitrile are generally polymerized in the polyetherol in the presence of a macromonomer (also referred to as macromer) (styrene-acrylonitrile polymer, SAN).

The macromer fulfills the function of steric stabilization of the SAN particles which form, and thus prevents agglomeration or flocculation of the SAN particles. In addition, the amount of macromer used can control the particle sizes. The macromers used are typically polyfunctional polyetherols which have subsequently been provided with an unsaturated bond which can be free-radically polymerized with the monomers.

After the free-radical polymerization of the unsaturated monomers, graft polyols are subjected to a purification step. The removal of volatile compounds, for example remaining monomers, volatile organic compounds (VOCs), degradation products, by-products, solvents, water, alcohols, additives, odorous and emissions-relevant substances, from the graft polyols is typically performed at elevated temperatures under reduced pressure.

The purification or stripping of polymer polyols (PMPOs) is described in “Chemistry and Technology of Polyols for Polyurethanes”, Mihail Ionescu, Rapra Technology Limited, 2005, p. 210-213. The stripping of an azeotropic mixture of styrene and water and stripping under reduced pressure in a countercurrent system (steam stripping, nitrogen stripping) have been described. Countercurrent stripping can be effected batchwise or continuously using conventional columns with trays.

The batchwise vacuum stripping of graft polyesterols is described in EP 0622384. The batchwise vacuum stripping of graft polyetherols which are prepared batchwise is described in EP 0664306 and EP 0353070, and the batchwise vacuum stripping of graft polyetherols which are prepared continuously in WO 0000531 and WO 03097710. Continuous stripping in packed columns using steam as a stripping agent is disclosed in US 020080033139 and EP 1873170.

Styrene and many other compounds, even in small amounts, cause an unpleasant odor and/or unwanted emissions, and therefore have to be removed substantially completely in the end product or earlier.

During the customary stripping operation, the graft polyols are exposed to high temperatures for a long time, which can cause the following problems among others:

Owing to thermal changes in the polymer structures, such as degradation reactions, depolymerization, crosslinking of polymer particles, the quality of the dispersion is worsened; for example, there may be phase separation, an increase in viscosity owing to crosslinking, poorer filtration properties, evolution of color and odor.

In addition, usually only very long stripping times can achieve a desired low content of volatile compounds. The long stripping time in turn leads to bottlenecks in the production, and hence to a reduction in the production capacity.

The problems mentioned cannot be remedied by the stripping processes known to date.

It was consequently an object of the present invention to provide a flexible, simple and economic process for stripping polyol dispersions, which avoids long exposure of the dispersions to high temperatures and gives a good and reproducible product quality.

### DESCRIPTION OF THE INVENTION

It has now been found that, surprisingly, the abovementioned object is achieved by a process for purifying polyol dispersions comprising at least one polyol and at least one filler, which comprises stripping the polyol dispersion by means of at least one rotating body.

The present invention therefore provides a process for purifying a polyol dispersion comprising at least one polyol and at least one filler, which comprises stripping the polyol dispersion by means of at least one rotating body.

The present invention further also provides a polyol dispersion obtainable by the process according to the invention, for the use of the polyol dispersion preparable by the process according to the invention for preparing polyurethanes, and a polyurethane obtainable using the polyol dispersion preparable in accordance with the invention.

The present invention thus provides a process for purifying polyol dispersions, which is flexible in terms of the process and economically viable.

After passing through the process according to the invention, a polyol dispersion generally comprises a significantly lower proportion of volatile compounds than before commencement of the process according to the invention. In addition, the content of volatile compounds after passing through the process according to the invention is generally also no higher than after passing through a conventional purification process.

The further product properties of a polyol dispersion, for example the shape and size of the particles present in the polyol dispersion, are generally maintained after passing through the process according to the invention.

At least one of the rotating bodies may be present as a rotating disk, and may be configured in the form of a simple disk, vase, ring or cone, preference being given to a horizontal rotating disk or to one deviating from the horizontal by up to 45° C. All rotating bodies are preferably in the form of rotating disks.

Normally, the rotating bodies each have a diameter of 0.10 m to 3.0 m, preferably 0.20 m to 2.0 m and more preferably of 0.20 m to 1.0 m. The surface may be smooth or have, for example, indentations in the form of grooves or spirals, which exert an influence on the mixing and the residence time of the reaction mixture.

The speed of rotation of the body and the metering rate of the mixture are variable. The speed of rotation is typically, in revolutions per minute, 1 to 20 000, preferably 100 to 5000 and more preferably 200 to 2000.

The volume of the reaction mixture present on the rotating body per unit area of the surface is typically 0.03 to 40 ml/(dm²), preferably 0.1 to 10 ml/(dm²), more preferably 1.0 to 5.0 ml/(dm²).

The average residence time (mean frequency of the residence time spectrum) of the ingredients of the mixture on the surface of one of the rotating bodies depends on the size of the surface, the type of the organic compound and the amount of water present, the temperature of the surface and the speed of rotation of the rotating body A. It is normally between 0.01 and 60 seconds, preferably between 0.1 and 30 seconds, especially 0.5 to 20 seconds, and can therefore be considered to be extremely short. This ensures that the extent of possible decomposition reactions and the formation of undesired products is greatly reduced, and hence the quality of the substrates is maintained.

The average residence time of the ingredients of the mixture on the surface on all rotating bodies is preferably in each case between 0.01 and 60 seconds, preferably between 0.1 and 30 seconds, especially 0.5 to 20 seconds.

At least one of the rotating bodies is preferably positioned in a container or housing, especially in a container or housing resistant with regard to the conditions of the process according to the invention. Especially preferably, all rotating bodies are positioned in one housing each, or all rotating bodies are positioned in one and the same housing. Together with the housing and any further rotating bodies present in the same housing, a rotating body constitutes a reactor.

The process according to the invention can be performed at standard pressure or slightly elevated pressure, and in an atmosphere of dry protective gas. However, it may also be appropriate to generate a reduced pressure, in which case pressures in the particular housing between 0.001 mbar and 1100 mbar, preferably between 0.01 mbar and 500 mbar, more preferably between 0.1 mbar and 100 mbar, have been found to be advantageous.

A preferred embodiment of the present invention further envisages that vapor, for example steam, a gas, for example dry air and/or inert gas, preferably nitrogen, is used to improve the removal of volatile components.

In a preferred embodiment, the mixture on the surface of at least one of the rotating bodies is in the form of a film which has an average layer thickness between 0.1 μm and 20.0 mm, preferably between 1 μm and 10 mm and more preferably between 10 μm and 2 mm. The mixture is more preferably present on the surface of each rotating body in the form of a film which has an average layer thickness between 0.1 μm and 20.0 mm, preferably between 1 μm and 10 mm and more preferably between 10 μm and 2 mm.

The temperature of at least one rotating body is generally between 20 and 400° C., preferably between 80 and 300° C. and more preferably between 100 and 270° C. The temperature of each rotating body is preferably between 20 and 400° C., especially between 80 and 300° C. and more preferably between 100 and 270° C.

In one embodiment of the invention, at least one of the rotating bodies is positioned in a housing, the inner wall temperature of which is between 0 and 300° C., preferably between 10 and 250° C. and more preferably between 20° C. and 100° C., the wall temperature preferably being lower than the temperature of the rotating body. More preferably, all rotating bodies are positioned in one housing each or in the same housing, the inner wall temperature(s) of (each) of which is/are between 0 and 300° C., preferably between 10 and 250° C. and more preferably between 20° C. and 100° C., the particular inner wall temperature preferably being lower than the temperature of the particular rotating body.

In a further embodiment of the process according to the invention, the reactor is operated isothermally, i.e. at least one of the rotating bodies, preferably in the form of a disk, and any further rotating bodies present in the same housing, preferably likewise each in the form of a disk, and the inner wall of the housing have the same temperature.

The product is then degassed both on the rotating bodies present in the housing, preferably in each case in the form of one or more superposed disks, and on the inner wall of the housing. The cooling then preferably takes place in a downstream heat exchanger.

For effective purification, it may also be appropriate to pass the mixture more than once over the surface of a rotating body.

In a further embodiment of the invention, the surface extends to further rotating bodies, such that the mixture passes from the surface of one rotating body onto the surface of at least one further rotating body.

Typically, in that case, one rotating body feeds the further bodies with the reaction mixture. Alternatively, the reaction mixture flows from one rotating body to the next.

Preference is given to using up to 10 rotating bodies connected in parallel or in series. In this embodiment, the reactor is operated isothermally.

In one embodiment of the process according to the invention, at least two rotating bodies are used, in which case the at least two rotating bodies are used in series or in parallel.

The overall average residence time of the ingredients of the mixture on the surface of all rotating bodies is, in the case of more than one rotating body, preferably from 10 seconds to 2 minutes.

As already mentioned above, the polyol dispersions to be purified comprise a continuous phase (liquid) and a solid phase dispersed in the continuous phase.

The continuous phase comprises at least one polyol, and optionally further components.

The polyols present in the polyol dispersion are preferably selected from the families of the polyether polyols, polyester polyols, polyether polyester polyols, polycarbonate polyols, poly-THF polyols, and mixtures thereof, particular preference being given to polyether polyols.

The polyether polyols preferably have a molecular weight (Mn) of 300-20 000 g/mol, preferably 400-6000 g/mol, and/or preferably an OH number of 20-900 mg KOH/g, more preferably 25-500 mg KOH/g.

The solid phase of the polyol dispersion comprises, as mentioned, fillers. The fillers are preferably selected from polymeric, organic or inorganic fillers, or a mixture thereof.

For example, the fillers may be selected from the group comprising polystyrene, poly(styrene-co-acrylonitrile), polyacrylonitrile, polyacrylate, polymethacrylate, polyolefins, for example polypropylene, polyethylene, polyisobutylene, polybutadiene, polyester, polyamide, polyvinyl chloride, polyethylene terephthalate, polyethylene glycol, sulfur, phosphorus, silicate materials (for example silica nanoparticles), metal oxides, metal carbonates, inorganic salts, inorganic pigments, carbon (for example graphite, nanotubes, fibers), melamine, urea, cellulose (for example fibers, nanoparticles, crystalline cellulose), or mixtures thereof.

In one embodiment, the mean particle size of the fillers is 0.05 μm-500 μm, preferably 0.1 μm-50 μm.

The distribution of the fillers may be monomodal, bimodal or multimodal.

The fillers may be mixed with one another. The amount of the fillers, based on the overall mixture, is preferably between 1 and 70% by weight, more preferably between 5 and 55% by weight.

In one embodiment, the polyol dispersion, after the last process step of the process according to the invention, has a content of volatile, especially organic, substances of <500 ppm, preferably of <50 ppm. The polyol dispersion, after passing through the process according to the invention, preferably has a styrene content of <10 ppm.

The present invention is also directed to polyol dispersions obtainable by the process according to the invention.

The polyol dispersions obtainable by the process according to the invention can be used to prepare polyurethanes. The polyurethanes thus obtainable likewise form part of the subject matter of the present invention.

The polyurethanes prepared in this way may, for example, be rigid or flexible polyurethane foams. Especially in applications in which low emission of volatile substances is of significance, the polyurethanes prepared in accordance with the invention can be used advantageously. Examples include the use of polyurethanes prepared in accordance with the invention as a raw material for mattresses or in automobile construction.

The invention therefore further provides a process for preparing a polyurethane by reacting a polyol dispersion preparable or purifiable by the process according to the invention with one or more organic diisocyanates (or polyisocyanates).

The polyurethanes can be prepared by the known processes, batchwise or continuously, for example with reactive extruders or the belt process, by the “one-shot” or the prepolymer process (including multistage prepolymer processes as in U.S. Pat. No. 6,790,916B2, preferably by the “one-shot” process. In these processes, the components being reacted (polyol, chain extender, isocyanate and optionally assistants and additives (especially UV stabilizers)) may be mixed successively or simultaneously with one another, and the reaction sets in immediately.

Polyurethanes are generally prepared by reacting diisocyanates with compounds having at least two hydrogen atoms reactive with isocyanate groups, preferably difunctional alcohols, more preferably with the polyol dispersions preparable or purifiable in accordance with the invention.

The diisocyanates used are customary aromatic, aliphatic and/or cycloaliphatic diisocyanates, for example diphenylmethane diisocyanate (MDI), tolylene diisocyanate (TDI), tri-, tetra-, penta-, hexa-, hepta- and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, 4,4′-, 2,4′- and/or 2,2′-dicyclohexylmethane diisocyanate.

The compounds reactive toward isocyanates used are, as described, the polyol dispersions preparable or purifiable in accordance with the invention. In a mixture therewith, it is possible to use commonly known polyhydroxyl compounds with molecular weights (Mn) of 500 to 8000 g/mol, preferably 600 to 6000 g/mol, and preferably of mean functionality from 1.8 to 8, preferably 1.9 to 6, especially 2, for example polyester alcohols, polyether alcohols and/or polycarbonatediols.

The compounds reactive toward isocyanates also include the chain extenders. The chain extenders used may be commonly known compounds, especially difunctional compounds, for example diamines and/or alkanediols having 2 to 10 carbon atoms in the alkylene radical, especially ethylene glycol and/or 1,4-butanediol, and/or hexanediol and/or di- and/or trioxyalkylene glycols having 3 to 8 carbon atoms in the oxyalkylene radical, preferably corresponding oligopolyoxypropylene glycols, and it is also possible to use mixtures of the chain extenders. The chain extenders used may also be 1,4-bis(hydroxymethyl)benzene (1,4-BHMB), 1,4-bis(hydroxyethyl)benzene (1,4-BHEB) or 1,4-bis(2-hydroxyethoxy)benzene (1,4-HQEE). Preferred chain extenders are ethylene glycol and hexanediol, more preferably ethylene glycol.

Typically, catalysts which accelerate the reaction between the NCO groups of the diisocyanates and the hydroxyl groups of the structural components are used, for example tertiary amines such as triethylamine, dimethylcyclohexylamine, N-methylmorpholine, N,N′-dimethylpiperazine, 2-(dimethylaminoethoxy)ethanol, diazabicyclo[2.2.2]octane and the like, and also especially organic metal compounds such as titanic esters, iron compounds, for example iron(III) acetyl-acetonate, tin compounds, such as tin diacetate, tin dilaurate or the dialkyltin salts of aliphatic carboxylic acids, such as dibutyltin diacetate, dibutyltin dilaurate or the like. The catalysts are typically used in amounts of 0.0001 to 0.1 part by weight per 100 parts by weight of polyhydroxyl compound.

In addition to catalysts, it is also possible to add customary assistants to the structural components. Examples include surfactants, flame retardants, nucleators, lubricating and demolding aids, dyes and pigments, inhibitors, stabilizers against hydrolysis, light, heat, oxidation, discoloration or microbial degradation, inorganic and/or organic fillers, reinforcers and plasticizers.

Further details about the abovementioned assistants and additives can be found in the specialist literature, for example in “Plastics Additive Handbook”, 5th Edition, H. Zweifel, ed., Hanser Publishers, Munich, 2001, H. Saunders and K. C. Frisch “High Polymers”, volume XVI, Polyurethane [Polyurethanes], parts 1 and 2, Interscience Publishers 1962 and 1964, Taschenbuch für Kunststoff-Additive [Plastics additives handbook] by R. Gachter and H. Muller (Hanser Publishers Munich 1990) or DE-A 29 01 774.

Apparatus for preparation of polyurethanes is known to those skilled in the art; see, for example, Kunststoffhandbuch [Plastics handbook], volume VII, Polyurethane [Polyurethanes], Carl Hanser publishers, Munich 1st edition 1966, edited by Dr. R Vieweg and Dr. A. Höchtlen, and 2nd edition 1983 and the 3rd revised edition 1993, edited by Dr. G. Oertel.

### FIGURES

FIG. 1 shows an exemplary embodiment of a rotating body as may find use in the process according to the invention. In this context, the abbreviation SDR stands for “spinning disk reactor”.

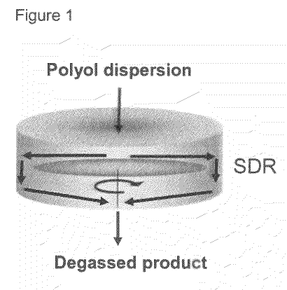

This shows a rotating disk positioned in a container which is fed continuously with polyol dispersion from the top. The degassed product is cooled at the wall and discharged at the bottom.

### EXAMPLES

Some examples will be described hereinafter to illustrate the invention. These examples shall in no way restrict the scope of protection of the present invention; they should merely be understood as an illustration.

In all examples, a modified version of a reactor described in documents WO00/48728, WO00/48729, WO00/48730, WO00/48731 and WO00/48732 was used.

The rotating body was a disk of diameter 10 cm. This body can be cooled or heated with liquid within a range from −5° C. to +300° C., and can rotate from 10 rpm (rpm=revolutions per minute) up to 3000 rpm. A gear pump can meter in the starting materials.

The quench device was a metallic wall within which coolant flows.

The starting materials can be preheated in a static mixer-heat exchanger upstream of the rotating body.

In all examples, a graft polyol of the following composition was used: poly(styrene-co-acrylo-nitrile) dispersion (solids content 45%) in glycerol-started PO-rich polyether polyol (Mw 2800 g/mol, OH#55 mg KOH/g).

### Example 1

### Demonomerization in an SDR Cascade

### 3 Passes

The residual monomer content to be removed was approx. 2300 ppm for acrylonitrile and approx. 4500 ppm for styrene.

The graft polyol was conducted 3 times through the same apparatus, which comprised a rotating disk of diameter 10 cm. The disk was heated internally with a heating medium. The heating medium had a temperature of approx. 250° C. The product was conducted over the disk at 15 ml/min. In order to promote the demonomerization, in addition to reduced pressure between 0.6 and 2 mbar, a nitrogen stream of 0.05 standard liter/h was passed over the disk. The following table shows the process conditions of the 3 passes:

TABLE 1
Process conditions for example 1

| | | | Feed | Disk | Jacket |
|---|---|---|---|---|---|
| | Pressure | Feed | temperature | temperature | temperature |
| Pass | mbar | ml/min | ° C. | ° C. | ° C. |
| 1 | 1.45 | 15 | 67 | 247 | 59 |
| 2 | 0.77 | 15 | 67 | 247 | 59 |
| 3 | 0.68 | 15 | 66 | 247 | 59 |

After 3 passes, it was possible to achieve a depletion of acrylonitrile from 2300 ppm to less than 10 ppm, and the residual acrylonitrile content was already less than 10 ppm after 2 passes. Styrene was depleted from 4500 ppm to 220 ppm. The table which follows summarizes the experimental results:

TABLE 2
Experimental results from example 1

| | Styrene | Acrylonitrile |
|---|---|---|
| Sample | ppm | ppm |
| Feed 1 | 4500 | 2300 |
| Result 1 = feed 2 | 1000 | 160 |
| Result 2 = feed 3 | 430 | <10 |
| Result 3 | 220 | <10 |

### Example 2

### Demonomerization in an SDR Cascade

### 8 Passes

The residual monomer content to be removed was approx. 2400 ppm for acrylonitrile and approx. 4600 ppm for styrene.

In order to achieve depletion to the target values, the graft polyol is conducted 8 times through the same apparatus, which comprises a rotating disk of diameter 10 cm. The disk is heated internally with a heating medium. The heating medium has a temperature of approx. 250° C. The product is conducted over the disk at 15 ml/min. In order to promote the demonomerization, in addition to reduced pressure between 0.5 and 2 mbar, a nitrogen stream of 0.05 standard liter/h is passed over the disk. The table which follows shows the process conditions of the 8 passes:

TABLE 3
Process conditions for example 2

| | | | Feed | Disk | Jacket |
|---|---|---|---|---|---|
| | Pressure | Feed | temperature | temperature | temperature |
| Pass | mbar | ml/min | ° C. | ° C. | ° C. |
| 1 | 1.48 | 15 | 67 | 248 | 60 |
| 2 | 0.79 | 15 | 67 | 248 | 60 |
| 3 | 0.69 | 15 | 67 | 248 | 60 |
| 4 | 0.66 | 15 | 67 | 248 | 60 |
| 5 | 0.65 | 15 | 67 | 248 | 60 |
| 6 | 0.6 | 15 | 67 | 248 | 60 |
| 7 | 0.58 | 15 | 67 | 248 | 60 |
| 8 | 0.57 | 15 | 67 | 248 | 60 |

After 8 passes, a depletion of acrylonitrile from 2400 ppm to the target value of <5 ppm can be achieved, and the residual acrylonitrile content is already less than 5 ppm after 3 passes. Styrene can be depleted from 4600 ppm to the target value of <10 ppm after 8 passes. The following table summarizes the experimental results:

TABLE 4
Experimental results from example 2

| | Styrene | Acrylonitrile |
|---|---|---|
| Sample | ppm | ppm |
| Feed 1 | 4600 | 2400 |
| Result 1 = feed 2 | 1100 | 180 |
| Result 2 = feed 3 | 440 | 8 |
| Result 3 = feed 4 | 200 | <5 |
| Result 4 = feed 5 | 110 | <5 |
| Result 5 = feed 6 | 50 | <5 |
| Result 6 = feed 7 | 26 | <5 |
| Result 7 = feed 8 | 16 | <5 |
| Result 8 | <10 | <5 |

As becomes clear from the examples, the graft polyols can be depleted down to the desired content of volatile components in a very short stripping time within the range of seconds to minutes. The short stripping time leads to significantly lower stress on the graft polyols at high temperatures. The occurrence of thermal alterations of the polymer structures, such as degradation reactions, depolymerizations, crosslinking resulting in viscosity increases, and alterations to color and odor, can be reduced significantly.

A further advantage of the process according to the invention is a possible increase in the production capacities, since the stripping operation frequently constitutes a bottleneck in the overall production chain.

1) A process for purifying a polyol dispersion comprising at least one polyol and at least one filler, which comprises stripping the polyol dispersion by means of at least one rotating body.

2) The process according to claim 1, wherein at least one of the rotating bodies is in the form of a rotating disk.

3) The process according to claim 1 or 2, wherein the polyol dispersion is on the surface of at least one of the rotating bodies in the form of a film which has an average layer thickness between 0.1 μm and 20.0 mm, preferably between 1 μm and 10 mm, and/or wherein the average residence time of the ingredients of the mixture on the surface of at least one of the rotating bodies is between 0.01 and 60 seconds, preferably between 0.1 and 30 seconds, and/or wherein the temperature of at least one of the rotating bodies is between 20 and 400° C., preferably between 80 and 300° C.

4) The process according to any of claims 1 to 3, wherein at least two rotating bodies are used, and the at least two rotating bodies are used in series or in parallel.

5) The process according to any of claims 1 to 4, wherein at least one of the rotating bodies is positioned in a housing.

6) The process according to claim 5, wherein the pressure in the housing during the process is between 0.001 mbar and 1100 mbar, preferably between 0.01 mbar and 500 mbar, more preferably 0.1 to 100 mbar.

7) The process according to either of claims 5 and 6, wherein the inner wall temperature of the housing is between 0 and 300° C., preferably between 10 and 250° C. and more preferably between 20° C. and 100° C.

8) The process according to any of claims 1 to 7, wherein the polyols present in the polyol dispersion are selected from the families of the polyether polyols, polyester polyols, polyether polyester polyols, polycarbonate polyols or poly-THF polyols, or mixtures thereof, preferably from the family of the polyether polyols.

9) The process according to claim 8, wherein the polyether polyols have a molecular weight of 300-20 000 g/mol, preferably of 400-6000 g/mol, and/or wherein the polyether polyols have an OH number of 20-900 mg KOH/g, preferably of 25-500 mg KOH/g.

10) The process according to any of claims 1 to 9, wherein the fillers present in the polyol dispersion are selected from polymeric, organic or inorganic fillers, or a mixture thereof. 811) The process according to claim 10, wherein the mean particle size of the fillers is 0.05 μm-500 μm, preferably 0.1 μm-50 μm, and/or wherein the distribution of the fillers is monomodal, bimodal or multimodal.

12) The process according to any of claims 1 to 11, wherein the polyol dispersion after the last process step has a content of volatile substances of <500 ppm, preferably <50 ppm.

13) A polyol dispersion obtainable by the process according to any of claims 1 to 12.

14) The use of the polyol dispersion according to claim 13 for preparation of polyurethanes.

15) A polyurethane obtainable using polyol dispersions according to claim 13.
